(19) United States
(12) Patent Application Publication
(10) Pub. No.: US 2016/0243668 A1
(43) Pub. Date: Aug. 25, 2016

(54) ADVANCING DEVICE FOR GENERATING A SECONDARY ADVANCING MOVEMENT OF A TOOL

(71) Applicant: GEHRING TECHNOLOGIES GMBH, Ostfildern (DE)

(72) Inventors: Andreas WIENS, Bietigheim-Bissingen (DE); Manuel WAIBLINGER, Stuttgart (DE); Andreas WAGNER, Esslingen (DE); Klaus LITTY, Kernen (DE)

(21) Appl. No.: 15/028,230

(22) PCT Filed: Aug. 28, 2014
(86) PCT No.: PCT/EP2014/068254

§ 371 Date: Apr. 8, 2016

(30) Foreign Application Priority Data
Oct. 11, 2013 (DE) 10 2013 220 507.4

(51) Int. Cl. B24B 33/08; B23B 29/034; B24B 33/02

(52) U.S. Cl. CPC B24B 33/088; B24B 33/02; B23B 29/03432; B23B 2260/108

(57) ABSTRACT

A device for producing a non-cylindrical inner surface of a bore having machining tools arranged along the bore's circumference and can be radially advanced towards the bore's inner surface includes a primary advancing system having an axially movable advancing rod for actuating the machining tools, thus exerting a primary force onto a machining tool, which is radially advanceable towards the bore by the primary force, which is dynamically superimposed with a secondary force generated by a secondary advancing system that forms an integral unit together with the primary advancing system or can be constructed in a modular manner. The secondary advancing system activates dependent on a current rotational movement and/or a stroke movement of the primary advancing system, a current tool position, or a specified advancing force, or the secondary advancing system activates at a specified time. In the process, the tool is already widened by the primary advancement.

The invention concerns a device for generating a noncylindrical inner surface of a bore with machining tools arranged along the circumference of the bore and radially fed up to the noncylindrical inner surface of the bore, wherein the device comprises a primary advancing system, which comprises an axially movable feed rod for activating the machining tools and thereby creates a primary force on at least one machining tool, by which the at least one machining tool can be radially fed up to the bore. Furthermore, the invention concerns a method for generating a noncylindrical inner surface of a bore with machining tools arranged along the circumference of the bore and radially fed up to the noncylindrical inner surface of the bore, wherein the device comprises a primary advancing system, by which an axially movable feed rod is moved axially for activating the machining tools and thereby creates a primary force on at least one machining tool, by which the at least one machining tool can be radially fed up to the bore, and a control unit for operating a device for generating a noncylindrical inner surface of a bore with machining tools arranged along the circumference of the bore and radially fed up to the inner surface of the bore, and with a primary advancing system.

The device in question for the machining of a bore is preferably a device for machining of bores by honing, but is not limited to this.

Honed bores must maintain very precisely a given geometry. However, many tools with honed bores become nonround during assembly (mechanical stress) and/or during operation on account of forces or due to temperature-related deformations. These shape changes are changes with respect to an ideal cylindrical shape. In order to compensate for such shape changes in a process-secure and economical manner already during the honing, the bores are deliberately provided with a noncylindrical bore surface, which then takes on the desired cylindrical shape as a result of the deformations which occur.

The aforementioned problem is becoming increasingly severe due to designs of machines and subassemblies with light construction and thin walls. This results in a lack of rigidity, so that the parts become deformed, e.g., during assembly, with loss of functional quality. In order to prevent this deleterious influence, free geometrical shapes are needed, corresponding to the acting loads, which differ substantially from the ideal geometrical shapes. The result is a providing of deformation conditions as part of the fabrication technology, leading to almost ideal part geometries under operating conditions and thus compensating for deformation influences.

For the machining of cylinder bores of internal combustion engines, the so-called shape honing process is known. Shape honing makes it possible to produce free form surfaces which depart locally from the ideal cylinder shape. For example, EP 2 277 662 A1 specifies a method for the production of noncylindrical bores. The dynamic advancement of the tool blades is done individually by radially acting piezo positioners in the tool. Besides the high tooling expense, this solution due to its design is only suitable from a diameter of around 70 mm or more.

DE 10 2008 064 592 A1 shows an infeed mechanism whose drive unit works piezo-hydraulically to adjust the honing stones. This hybrid variant makes possible a larger number of honing stones in the tool. Here as well, the costs are very high.

DE 10 2007 038 123 A1 likewise shows a device for generating noncylindrical bore surfaces. The tool blades of a machining tool (honing stones with bonded cutting grain or cutting edge of a cutting insert) can be radially advanced individually and independently of each other for different distances in dependence on the position in the bore. This is possible, e.g., with four coaxially arranged piezo positioners in the infeed mechanism of the machine, where a feed rod is axially arranged. With this, it is possible to produce any desired free forms whose noncylindrical envelope surfaces are defined by spatial coordinates.

Often one requires not any given free forms, but instead noncylindrical shapes with harmonic cross sections (such as ovals, equally thick workpieces, or “cloverleafs” in 2^{nd} to 4^{th} order) and/or truncated conical bores with round cross section (zeroth order) or the aforementioned harmonic cross section shapes of higher order. For producing such shapes, the devices known in the prior art are too costly and can only be used for larger bores (D>70 mm).

Therefore, the problem which the invention proposes to solve is to create a device which can also be used for the machining of bores with less than 70 mm diameter, wherein the device should have a simple construction, place relatively few demands on the machine controls, and be retrofittable and economical in cost.

As the solution of the problem, the invention proposes that the advancement force of a primary infeed mechanism is superimposed with the advancement force of a secondary infeed mechanism when needed, depending on the position and/or the angle of the device in the bore. As a rule, the primary advancing system and the secondary advancing system form an integrated unit. However, a modular construction is also conceivable.

The device according to the invention serves preferably for the shape honing of bores. The primary advancing system creates an advancement movement of the traditional kind. The secondary advancing system according to the invention dynamically superimposes on the primary advancement movement the secondary advancement movement according to the invention.

The overall advancement movement thus arises by the addition of the two advancement movements or the two advancement forces. The secondary advancing system according to the invention creates the additional advancement movement preferably in dependence on a current rotary and/or stroke position of the machining tool. Control is taken over by the machine's controls or takes place in a separate control unit, which for example ascertains on the basis of signals from sensors which are otherwise present on the honing machine the current rotary and/or stroke position of the tool and initiates the secondary advancement movement.

The advancement movement is transmitted by the feed rod, which is arranged coaxially in the device for generating the noncylindrical inner surface of the bore. The device according to the invention is simple and compact in construction and therefore suitable to machining bores which also have a diameter substantially smaller than 70 mm. Bores with diameters of 10 mm, for example, can be machined with no problem. Even smaller bores can be machined.

The dynamic superpositioning of the advancement movement created by the primary advancing system according to the invention with the advancement movement of the secondary advancing system is position-dependent, for example. This means that, depending on a particular stroke or rotary position of the machining tool in the bore or that of the feed rod, a dynamic additional influence is locally produced on the machining tool. This creates additional material removal there, generating the desired noncylindrical shape.

Bores with such machined bore surfaces result, for example in the pump elements of fuel injection pumps, in improved volumetric efficiencies, less wear, and higher delivery pressure.

The machining tools generally have honing stones with bonded grinding grains. Instead of the cutting stones with integrated grinding grains, the tool can also have cutting inserts with geometrically defined blade, so that a shape boring can be realized instead of a shape honing in the device according to the invention.

In a preferred embodiment it is proposed that the secondary advancing system comprises a piezo positioner. The piezo positioner is preferably designed as a piezoelectric linear actuator. The piezo positioner is activated by an electrical actuation, whereupon it temporarily extends in particular in the axial direction. This extension is additively superimposed on the advancement movement generated by the primary advancing system. In this way, an additional axial movement of the feed rod with a certain force and velocity is temporarily created for the radial advancement of the machining tools. In this process, conical surfaces of the axially running feed rod can interact in familiar fashion with complementary running advancement surfaces of the machining tools, for example, so that the axial movements of the feed rod is converted into a radial advancement movement of the machining tools.

Essentially, the advancement movement being superimposed by the secondary advancing system can occur in any given manner, i.e., electromechanically or hydraulically, as well as with force or path control.

Preferably, the secondary advancing system is arranged centrally or coaxially in the primary advancing system. This leads to a very compact device, which is suited to making noncylindrical bores with cross section shapes even of higher orders.

The amplitude of the secondary advancement movement can vary along the length of the bore. One can use traditional tools for this, so that costs are incurred only for the secondary advancing system according to the invention and its integration in the primary infeed mechanism.

In order to accomplish different cross section shapes of n-th order, one can employ tools with “n” honing stones. A cloverleaf cross section (4^{th} order) can be generated, e.g., with a 4-piece tool (4 honing stones) if the secondary advancement is briefly activated each time by a rotation of the tool of 90°. A conical trend of such a cross section shape can be realized in this way, since the degree of the advancement path can be varied along the length of the bore according to the desired variation of the envelope line.

Basically, the possibility exists of working with a one-piece machining tool. In this case, nearly all free forms are possible, but the machining time is longer than for a multi-piece tool.

In the device according to the invention several machining tools can preferably be moved by a single feed rod. The machining tools are then preferably arranged at the same angle to each other. This means that, if four machining tools are provided for example, they are arranged at an angle of 90° each about the feed rod; if only three machining tools are provided for example, they are arranged at an angle of 120° each about the feed rod.

The secondary advancing system in the device according to the invention can follow along with a stroke and rotary movement of the primary advancing systems. The electrical power supply comes from slip contacts, for example. Noncontact inductive transmission systems are also conceivable. Hence, the device according to the invention corresponds in outward appearance to the known devices for generating a bore with machining tools (honing tools) arranged along the circumference of the bore and radially fed up to the inner surface of the bore.

Alternatively to this, the secondary advancing system can also be decoupled from the rotary movement of the primary advancing system. For example, a rotary movement of a spindle of the device according to the invention can be decoupled by rotary bearings. This brings the advantage that the slip contacts (e.g., a rotary distributor) for the electrical power supply of the piezo positioner can be eliminated, since the piezo positioner is rotationally decoupled from the spindle and from the feed rod.

Moreover, it is possible to mount the secondary advancing system downstream from the primary advancing system in the axial direction. The primary advancing system will execute the familiar rotary and stroke movement, while the downstream secondary advancing system can be adapted as desired. In this way, the dynamic additional influencing of the machining tools is realized.

Furthermore, it is possible for the secondary advancing system to generate peak advancement pressures as an impulse. One can in this way generate peak advancement pressures which serve to promote the self sharpening of the cutting stones. These peak pressures cause an increased wear on the bonding, so that new raised cutting crystals are available during the honing.

In the method according to the invention it is furthermore possible for the secondary advancing system to be electrically biased from the outset, and the secondary advancing system will be relieved of load upon retraction of the device, since a previously imposed voltage will be reduced. This makes possible a position-guided relieving of the machining tools, for example, in order to avoid parabolic stroke reversal marks in edge regions of the bore, e.g., at stroke reversal points. The secondary advancing system can also be activated in dependence on a current tool position, a particular advancement force or at a particular time.

Important features for the invention will be found moreover in the following specification and in the drawing, where the features can be important to the invention either in themselves or in various combinations, without this being explicitly pointed out each time.

Sample embodiments of the invention are explained hereafter with the help of the figures, as examples. There are shown:

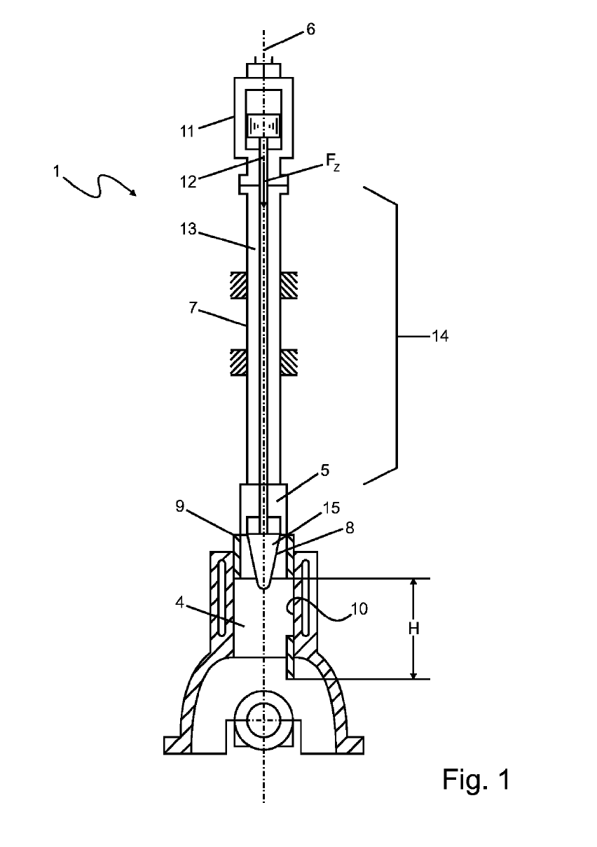

FIG. 1, a honing machine of the prior art;

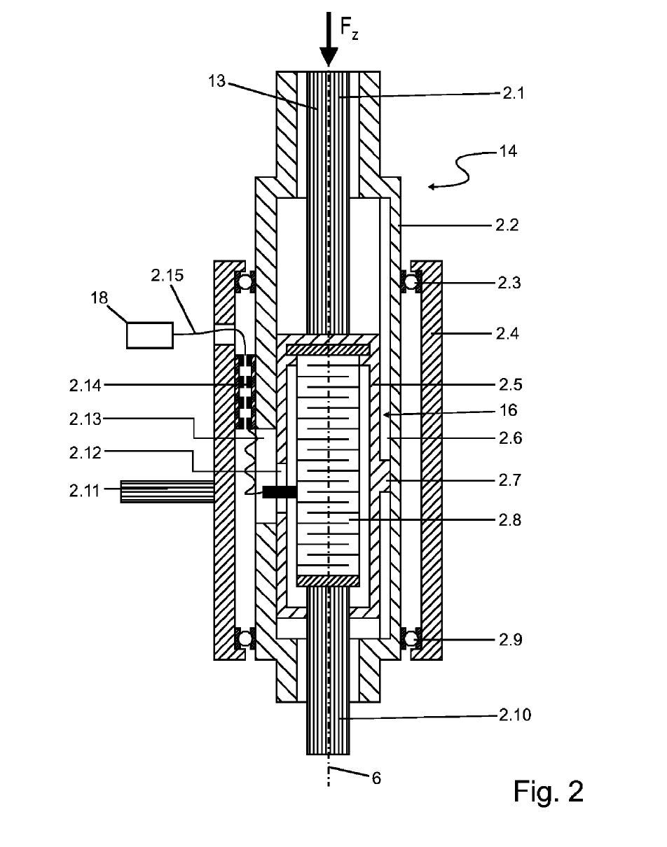

FIG. 2, a primary advancing system according to the invention in a first embodiment;

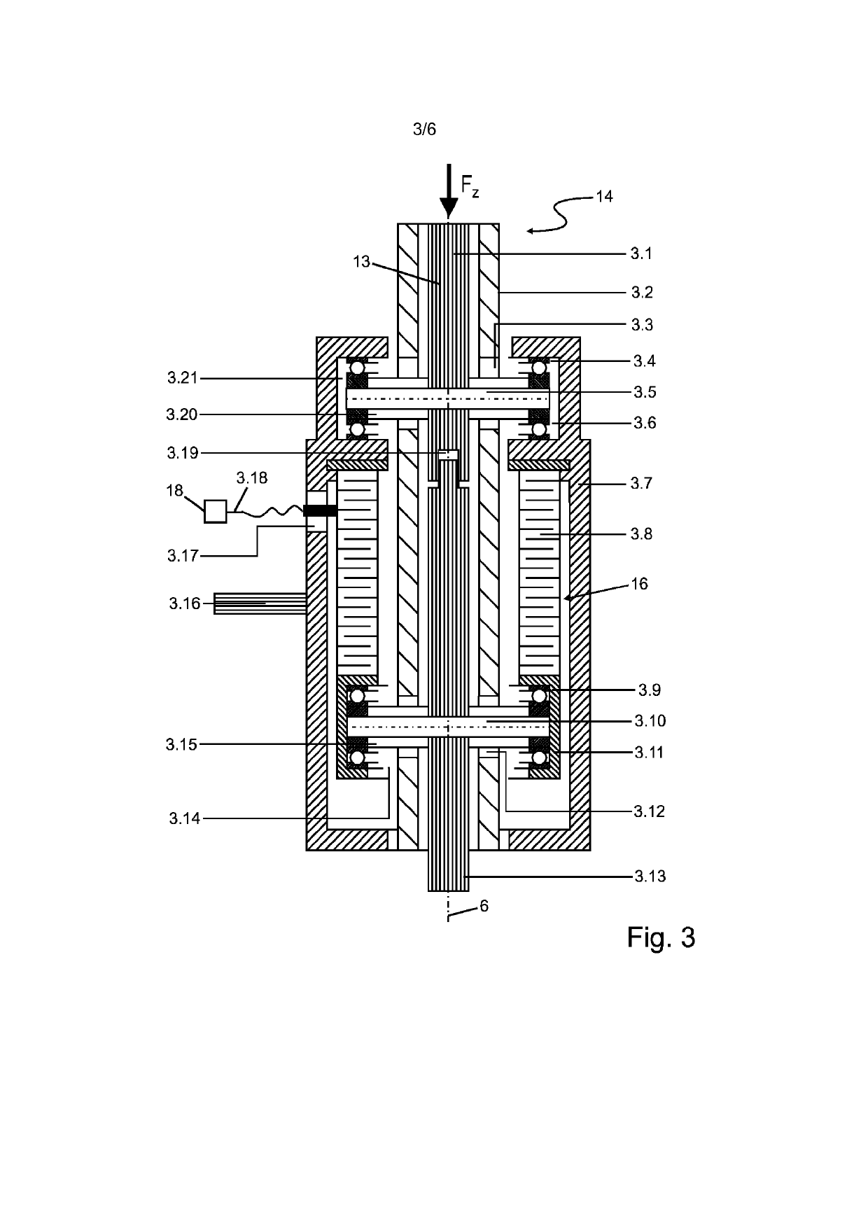

FIG. 3, a primary advancing system according to the invention in a second embodiment;

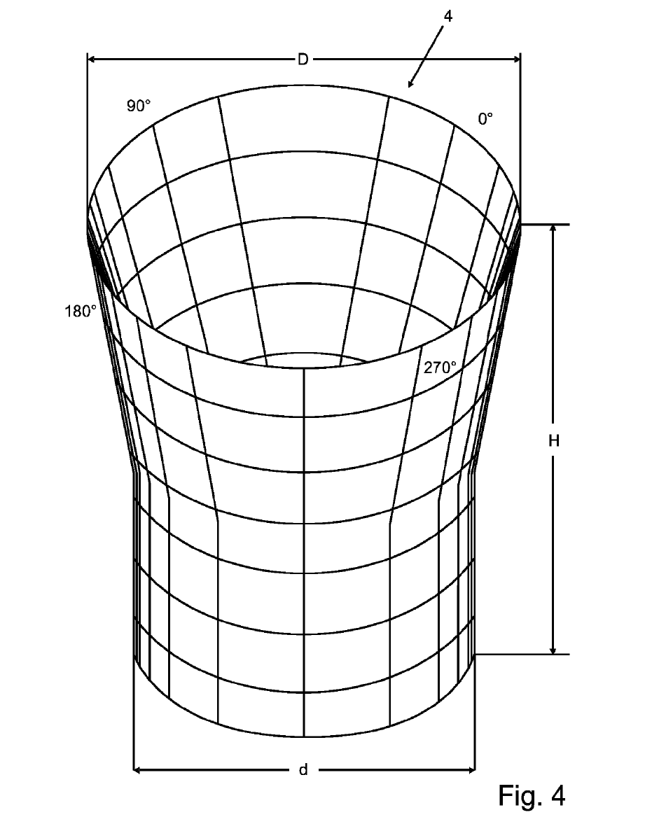

FIG. 4, a first noncylindrical bore which can be produced with the device according to the invention in a perspective representation;

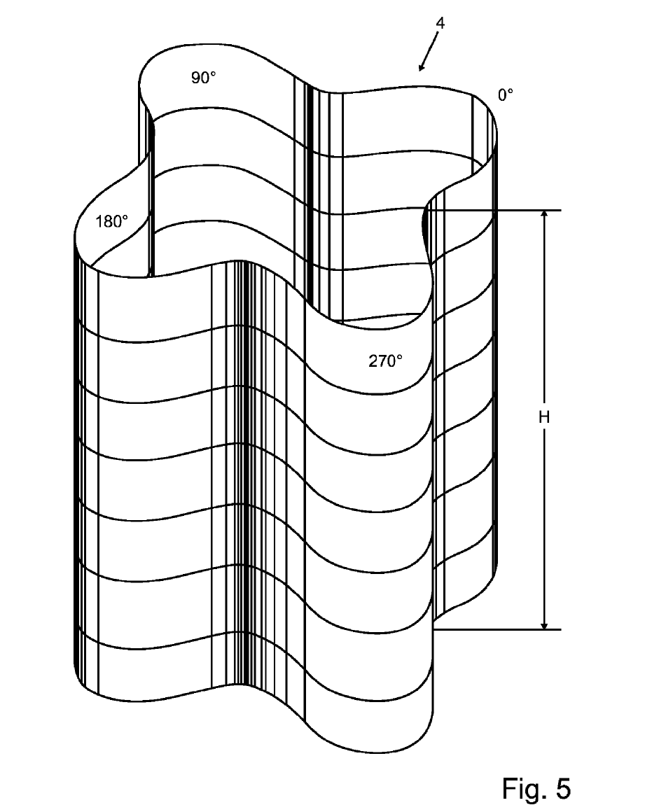

FIG. 5, a second noncylindrical bore which can be produced with the device according to the invention in a perspective representation; and

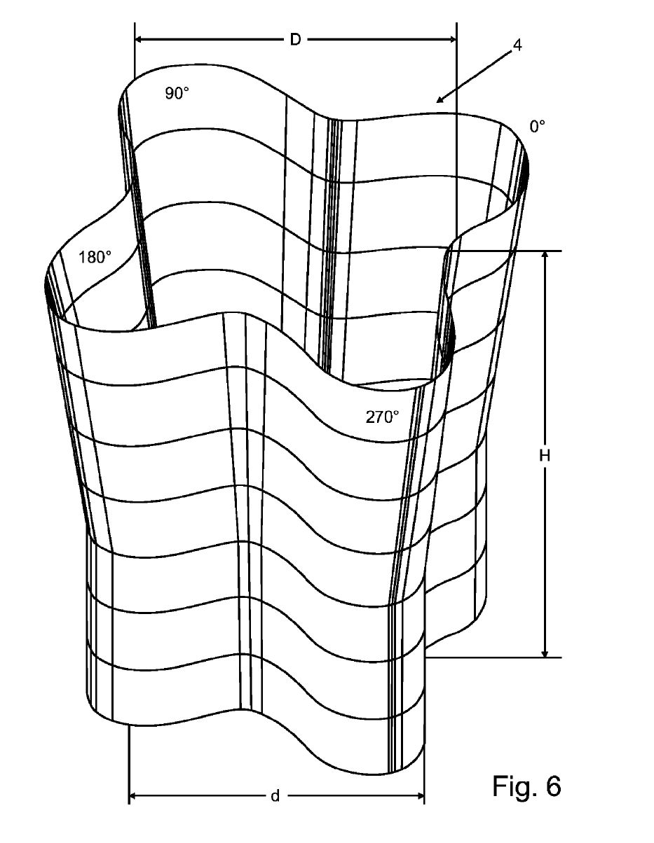

FIG. 6, a third noncylindrical bore which can be produced with the device according to the invention in a perspective representation.

FIG. 1 shows a honing device 1 of the prior art. The honing device 1 machines a cylinder bore 4 by a honing tool 5 driven in rotation in familiar fashion, while the honing tool 5 in addition to the rotary movement executes an oscillating stroke movement.

The honing tool 5 is connected for this purpose to a spindle 7, which is part of a honing machine (not shown) and which can move back and forth in the direction of the lengthwise axis of the bore being machined or the inner surface 10, for example by a hydraulic or electromechanical stroke drive unit. Furthermore, the spindle 7 is driven in rotation about its lengthwise axis 6 in familiar fashion by a rotary drive unit (not shown). The honing tool 5 carries machining tools 9 configured as honing stones, which can be fed radially outward by a hydraulically operated infeed mechanism and pressed against an inner surface 10 of the cylinder bore 4. The infeed mechanism could also be electrically operated, for example, by a servo motor. The hydraulic activation of the infeed mechanism consists of a piston and cylinder arrangement 11, whose piston rod 12 presses on the top side of an advancement cone 15 of the honing tool 5 via a feed rod 13 which is led axially to the honing tool 5 through the spindle 7.

The region of the feed rod 13 shall be designated hereafter the primary advancing system 14, while the infeed mechanism transmits a primary advancement force Fz to the primary advancing system 14. The primary advancement force Fz here can be generated hydraulically, electrically or in some other way.

The honing stones 9 have advancement surfaces 8 which are complementary in configuration to the advancement cone 15, so that the axial movement of the feed rod 13 is converted into a radial advancement movement of the machining tools 9. The feed rod 13 can also have a multi-piece configuration.

FIG. 2 shows a first sample embodiment of the present invention, the primary advancing system 14 without the “upstream” unit 11 for generating the primary advancement force, in detail. The primary advancing system 14 has a housing 2.4, in which a rotatable spindle 2.2 is axially led. The spindle 2.2 is mounted by radial bearings 2.3 and 2.9 in the housing 2.4. Thus, the housing 2.4 is rotationally decoupled from the spindle 2.2. In order to take up the frictional moments of the radial bearings 2.3 and 2.9, a torque pickup 2.11 is provided, which thrusts against a stroke-actuated end stop.

In the spindle 2.2, the feed rod 13 is arranged along the lengthwise axis 6. A primary force Fz acts axially on the feed rod 13 or the spindle 2.2, which acts on the primary advancing system 14.

The feed rod 13 in the primary advancing system 14 according to the invention has a three-piece configuration. The feed rod 13 in FIG. 2 comprises an upper feed pin 2.1, a lower feed pin 2.10 and between the two feed pins 2.1 and 2.10 a hollow cylindrical receiving device 2.5, which receives a cylindrical piezo positioner 2.8.

In the cavity of the receiving device 2.5 the piezo positioner 2.8 is firmly disposed at the upper end in FIG. 2. At the lower end of the piezo receiver 2.5 is arranged the lower feed pin 2.10.

The piezo positioner 2.8 extends in the lengthwise direction when an electrical voltage is applied. The electrical voltage is brought to the piezo positioner 2.8 across a rotary distributor 2.14, which is provided with slip contacts for example, or via a noncontact energy and signal transmitter. An electrical connection cable 2.15 is laid to the rotary distributor 2.14, the connection cable 2.15 being led on the inside through an oblong opening 2.13 of the housing 2.4 and through an oblong opening 2.12 in the receiving device 2.5 to the piezo positioner 2.8. The connection cable 2.15 leads out to a control unit (not shown), which supplies the piezo positioner 2.8 with electrical voltage so that the desired superimposed advancement movement results, specific to the workpiece.

Now, if the piezo positioner 2.8 is supplied with electrical voltage, the additional or secondary advancement movement of the piezo positioner 2.8 will be superimposed on the advancement movement generated by the advancement force Fz of the primary advancing systems 14. The lower feed pin 2.10 in FIG. 2 will move downward and act on the advancement cone 15 of the honing device 1 according to the description of FIG. 1, not shown in FIG. 2. The piezo positioner 2.8 with the receiving device 2.5 constitutes in the primary advancing system 14 according to the invention a secondary advancing system 16, by which the movement of the primary advancing system 14 can be dynamically superimposed with an additional movement by applying the electrical voltage to the piezo positioner 2.8.

The oblong openings 2.12 and 2.13 enable the axial extension of the secondary advancing system 16, without impairing the electrical contacting of the piezo actuator 2.8.

The receiving device 2.5 is led in the spindle 2.2 and additionally positioned firm to rotation, but axially movable, by a groove 2.6 with a feather key 2.7.

The device according to the invention serves preferably for the shape honing of bores. The primary advancing system 14 generates a traditional (primary) advancement movement in this process. The secondary advancing system 16 integrated in the primary advancing system 14 according to the invention dynamically superimposes the advancement movement generated by the primary force Fz with an additional advancement movement which is generated by the extension of the piezo positioner 2.8. The secondary advancing system 16 generates the additional advancement movement preferably in dependence on a current rotary and/or stroke position of the primary advancing systems 14. The control needed for this occurs in the control unit, which detects the current rotary and/or stroke movement for example by means of signals of correspondingly arranged sensors and triggers the additional advancement movement at given times. The advancement movement is transmitted by the feed rod 13, which “breathes” in its axial extension as a consequence of the applying of the electrical voltage to the piezo positioner 2.8.

The dynamic superimposing of the advancement movement generated by the primary advancing system 14 according to the invention with the advancement movement of the secondary advancing systems 16 thus occurs dependent on position and dependent on angle of rotation. This means that, depending on a particular position of the machining tools 9 in the bore 4 or that of the feed rod 13, a dynamic additional influencing of the machining tools 9 occurs locally.

FIG. 3 shows the primary advancing system 14 in a second embodiment of the present invention in detail view. The second embodiment can also be used to generate for example the bores 4 represented in FIGS. 4 to 6.

In the second sample embodiment the primary advancing system 14 has a housing 3.7 in which a rotatable spindle 3.2 is led axially. In the spindle 3.2 is arranged the feed rod 13 along the lengthwise axis 6. The feed rod 13 is acted upon axially by the primary force Fz which is generated by the primary advancing system 14. In the discussion of this sample embodiment as well, the terms “top” and “bottom” refer to the situation depicted in FIG. 3.

A piezo positioner 3.8 is arranged centrally in the housing 3.7, but unlike the first embodiment it is a hollow cylinder in configuration. Alternatively, three or more cylindrical piezo positioners can also be arranged uniformly about the circumference, for example.

The spindle 3.2 rotates in the cavity of the piezo positioner 3.8. The advancement force Fz acts on an upper feed pin 3.1 in FIG. 3, which is part of the feed rod 13.

The upper feed pin 3.1 has a transverse bore, through which a rotation pin 3.5 is led. On this upper rotation pin 3.5 is arranged the secondary advancing system 16, which is rotationally decoupled from a rotating upper feed pin 3.1 and from the rotating spindle 3.2. The upper rotation pin 3.5 protrudes by its ends into the bores of the upper rotation ring 3.20. At the upper rotation ring 3.20, axial bearings 3.4 and 3.6 lie against either side. The upper rotation pin 3.5, the rotation ring 3.20 and the two axial bearings 3.4 and 3.6 form the upper rotational bearing 3.21, which carries the housing 3.7 and is rotationally decoupled from the rotational movement of the spindle 3.2 with the upper feed pin 3.1.

An upper recess 3.3 and a lower recess 3.12 shown in FIG. 3 enable a relative movement of the secondary advancing system 16 to the spindle 3.2 in order to transmit the [missing noun] from the advancement force Fz of the primary advancing systems 14 via the outer, nonrotating part of the secondary advancing systems 16 to a lower feed pin 3.13.

Inside the housing 3.7 in FIG. 3 is located the hollow cylindrical piezo positioner 3.8. beneath the upper rotational bearing 3.21. It is firmly arranged in the housing 3.7 on the top side in the axial and radial direction and thus is rotationally decoupled from the spindle 3.2. The electrical supply of the piezo positioner 3.8 comes by way of a connection cable 3.18.

By applying an electrical voltage, the piezo positioner 3.8 is extended, which brings about an axial displacement of a lower rotational bearing 3.14. This lower rotational bearing 3.14 consists of a lower rotation pin 3.10 and two axial bearings 3.9 and 3.11. The lower rotation pin 3.10 in turn protrudes by its ends into the bores of the rotation ring 3.15. The lower feed pin 3.13 is firmly arranged on the lower rotation pin 3.10 in the axial direction.

The guide 3.19 essentially constitutes an interface between the upper feed pin 3.1 and the lower feed pin 3.13. With this guide, the lower feed pin 3.13 is given the ability to move axially when an electrical voltage is applied to the piezo positioner 3.8, and thus to temporarily, i.e., dynamically superimpose the advancement force of the secondary advancing system 16 thus generated on the advancement force Fz. The (overall) advancement movement so generated is transmitted to the feed rod 13, which “breathes” in its axial extension as a consequence of the applying of the electrical voltage to the piezo positioner 3.8.

The housing 3.7 has an opening 3.17, which allows for passage of the connection line 3.18 and also allows the axial movement of the piezo positioner 3.8 thanks to its oblong configuration. Since the piezo positioner 3.8 does not rotate in the second embodiment, a permanent electrical connection at the piezo positioner 3.8 is possible.

In both embodiments, the transmission of the superimposing advancement movement by the secondary advancing system 16 is force-controlled. Essentially, the superimposing advancement movement can occur in any desired manner, i.e., also electromechanically, path-controlled, or hydraulically.

FIGS. 4 to 6 show three embodiments of possible noncylindrical bores which can be made with the device according to the invention, each in perspective representation. In FIGS. 4 to 6, the effects which are created by the method according to the invention are presented in an exaggerated manner, for better comprehension.

FIG. 4 shows a first noncylindrical bore 4 which can be made with the device according to the invention. FIG. 4 shows a noncylindrical shape with round cross section (zero^{th} order), not with straight envelope lines, but instead cup-shaped or conical lengthwise curves of the bore in the case of rotational symmetrical forms. This means that the bore is round along the entire height H in cross section. The diameter increases in the axial direction, however, from the diameter d in the lower region of the bore to a diameter D in the upper region of the bore 4.

Such a configuration of the bore 4 is accomplished in the method according to the invention in that the electrical voltage present on the piezo positioner 2.8, or 3.8, i.e., in the secondary advancing system 16, is steadily increased with the upward stroke of the machining tools 9. In this way, the advancement force acting on the machining tools 9 increases steadily, which results in a steady widening of the bore. The widening in the case of a bore diameter of around 10 mm is in the micrometer range and is shown greatly exaggerated in FIG. 4.

FIG. 5 shows a second noncylindrical bore 4 which can be made with the device according to the invention. FIG. 5 shows a noncylindrical shape with constant harmonic cross sectional forms (for example, 2^{nd} to 4^{th} order), which is configured as a cloverleaf, for example. Oval diameters can also be realized with the method according to the invention. The form shown in FIG. 5 has the same cross section over the entire height H; i.e., it is prismatic. Such a configuration of the bore 4 is accomplished in the method according to the invention in that the applied electrical voltage on the piezo positioner 2.8 is continually increased and reduced according to a particular rotary position of the feed rod 13. In FIG. 5, the highest electrical voltage on the piezo positioner 2.8 occurs at 0°, 90°, 180° and 270° of the feed rod 13, after which it is again reduced, until it reaches a minimum at 45°, 135°, 225° and 315°. The voltage then increases again.

FIG. 6 shows a third noncylindrical bore 4 which can be made with the device according to the invention. FIG. 6 shows a noncylindrical shape which is a combination of the bores 4 from FIGS. 4 and 5. This means that a noncylindrical shape of a bore 4 is created with harmonic cross sectional forms, which are configured as a cloverleaf, for example, the lower diameter d represented in FIG. 6 widening toward the top with increasing height to the diameter D. This is realized in that the secondary advancing system 16 generates the additional advancement movement in dependence on a current rotary position and stroke position of the primary advancing system 14, while the electrical voltage applied at the piezo positioner 2.8 is adjusted according to the description for FIGS. 4 and 5.

1. Device for generating a noncylindrical inner surface (10) of a bore (4) with machining tools (9) arranged along the circumference of the bore (4) and radially fed up to the noncylindrical inner surface (10) of the bore (4), wherein the device comprises a primary advancing system (14), which comprises an axially movable feed rod (13) for activating the machining tools (9) and thereby creates a primary force (Fz) on at least one machining tool (9), by which the at least one machining tool (9) can be radially fed up to the bore (4), characterized in that a secondary advancing system (16) is provided coaxially to a primary advancing system (14), and the advancement movements of the primary advancing system (14) and the secondary advancing system (16) are added to give an overall advancement movement which is transmitted to all cutting blades (9) of a downstream tool (5).

2. Device according to claim 1, characterized in that the secondary advancing system (16) comprises one or more piezo positioners (2.8; 3.8).

3. Device according to claim 1, characterized in that the secondary advancing system (16) is arranged centrally and axially (coaxially) to the primary advancing system (14).

4. Device according to claim 1, characterized in that several machining tools (9) can be moved by a single feed pin (2.10, 3.13), and the feed pin (2.10, 3.13) transmits the overall advancement movement to all cutting blades (9) of a downstream tool (5).

5. Device according to claim 1, characterized in that the secondary advancing system (16) follows along with a stroke and rotary movement of the primary advancing system (14).

6. Device according to claim 1, characterized in that the secondary advancing system (16) is decoupled from the rotary movement of the primary advancing systems (14).

7. Device according to claim 1, characterized in that the secondary advancing system (16) is downstream in the axial direction from the primary advancing system (14).

8. Device according to claim 1, characterized in that the downstream tool is a honing tool (5) or a tool for fine boring with one or more cutting blades with geometrically defined cutting blade.

9. Method for generating a noncylindrical inner surface (10) of a bore (4) with machining tools (9) arranged along the circumference of the bore (4) and radially fed up to the noncylindrical inner surface (10) of the bore (4), wherein the device comprises a primary advancing system (14), by which an axially movable feed rod (13) is moved axially for activating the machining tools (9) and thereby creates a primary force (Fz) on at least one machining tool (9), by which the at least one machining tool (9) can be radially fed up to the bore (4), characterized in that the primary force (Fz) is dynamically superimposed with a secondary force, which is created by a secondary advancing system (16), wherein the secondary advancing system (16) is activated in dependence on a current rotary movement and/or stroke movement of the primary advancing system (14).

10. Method according to claim 9, characterized in that the method is carried out with a device according to claim 1.

11. Method according to claim 9, characterized in that the secondary advancing system (16) generates peak advancement pressures as an impulse.

12. Method according to claim 9, characterized in that the secondary advancing system (16) is electrically biased from the outset, and the secondary advancing system (16) is relieved of load upon retraction of the device, in that a previously imposed voltage is reduced.

13. Control unit for operating a device for generating a noncylindrical inner surface (10) of a bore (4) with machining tools (9) arranged along the circumference of the bore (4) and radially fed up to the inner surface (10) of the bore (4), and with a primary advancing system (14), characterized in that the control unit is programmed to employ one of the methods according to claim 9.

14. Device according to claim 2, characterized in that the secondary advancing system (16) is arranged centrally and axially (coaxially) to the primary advancing system (14).

15. Device according to claim 2, characterized in that several machining tools (9) can be moved by a single feed pin (2.10, 3.13), and the feed pin (2.10, 3.13) transmits the overall advancement movement to all cutting blades (9) of a downstream tool (5).

16. Device according to claim 2, characterized in that the secondary advancing system (16) follows along with a stroke and rotary movement of the primary advancing system (14).

17. Device according to claim 2, characterized in that the secondary advancing system (16) is decoupled from the rotary movement of the primary advancing systems (14).

18. Device according to claim 2, characterized in that the secondary advancing system (16) is downstream in the axial direction from the primary advancing system (14).

19. Device according to claim 2, characterized in that the downstream tool is a honing tool (5) or a tool for fine boring with one or more cutting blades with geometrically defined cutting blade.

20. Method according to claim 10, characterized in that the secondary advancing system (16) generates peak advancement pressures as an impulse.
